(19) United States
(12) Patent Application Publication
(10) Pub. No.: US 2011/0171738 A1
(43) Pub. Date: Jul. 14, 2011

(54) METHOD FOR ESTIMATING THE AMOUNT OF IMMOBILIZED PROBES AND USE THEREOF

(75) Inventors: Hiroyoshi AOKI, Wako-shi (JP); Yutaka YAMAGATA, Wako-shi (JP); Naoko KODAMA, Wako-shi (JP)

(73) Assignee: RIKEN, Wako-shi (JP)

(21) Appl. No.: 12/984,993

(22) Filed: Jan. 5, 2011

(30) Foreign Application Priority Data
Jan. 12, 2010 (JP) 2010-004309

(51) Int. Cl. G01N 21/76; G01N 30/00; B05D 1/04; B05C 5/00

(52) U.S. Cl. 436/86; 436/172; 436/94; 422/69; 422/430; 427/9; 118/712

(57) ABSTRACT

The present invention provides a method for estimating an amount of immobilized probes, including the successive steps of: providing a sample on a substrate to form one or more spots of the sample on the substrate, the sample containing particulate substances and probes in a predetermined ratio, the probes being reactive with a predetermined target; measuring the number of the particulate substances contained in at least one of the spots; and estimating the amount of the probes contained in the at least one of the spots from the thus measured number of the particulate substances.

This Nonprovisional application claims priority under 35 U.S.C. §119(a) on Patent Application No. 2010-004309 filed in Japan on Jan. 12, 2010, the entire contents of which are hereby incorporated by reference.

### TECHNICAL FIELD

The present invention relates to: a method for estimating the amount of immobilized probes, for example, nucleic acids; and the use thereof.

### BACKGROUND ART

In recent years, there has been developed a microarray with, for example, a dozen to several thousand DNAs or proteins applied in minute spots each having a diameter of about several hundred micrometers onto a chip measuring several centimeters per side. Such a microarray has been used in genomics work or proteome analysis.

Examples of a method of applying DNAs or proteins in the form of a spot in the microarray include photolithography, mechanical spotting, inkjet, and microcontact printing.

In order to attain a reliable and quantitative measurement result, it is necessary to form spots containing DNAs or proteins with high reproducibility. However, under present circumstances, any of the above methods has a technical difficulty in forming the spots with high reproducibility.

As described above, it is difficult to form the spots with high reproducibility. In the case of the microarray, preliminary evaluation of uniformity of the amount of DNAs or proteins contained in each of the spots is important for the attainment of a reliable and quantitative measurement result.

As an example of the method of evaluating uniformity of the amount of DNAs or proteins contained in each of the spots, Patent Literature 1 and Non-patent Literature 1 describe the following method using a DNA microarray. That is, after DNAs are labeled with a fluorescent dye such as fluorescein, the DNAs are applied in the form of spots onto the microarray, and each of the spots is evaluated in terms of a fluorescence value (the amount of fluorescence).

Further, Patent Literature 2 describes a method of performing quality control based on fluorescence values of quality control DNAs in sequential synthesis performed on a chip.

Still further, Patent Literature 3 describes a method of evaluating quality of a chip by hybridizing a fluorescently labeled DNA whose sequences are all complementary sequence to the chip.

### CITATION LIST

### Patent Literatures

### Patent Literature 1

Japanese Patent Application Publication (Translation of PCT Application), Tokuhyo, No. 2005-501237 A (Publication Date: Jan. 13, 2005)

### Patent Literature 2

Japanese Patent Application Publication (Translation of PCT Application), Tokuhyo, No. 2005-531315 A (Publication Date: Oct. 20, 2005)

### Patent Literature 3

Japanese Patent Application Publication, Tokukai, No. 2008-142020 A (Publication Date: Jun. 26, 2008)

### Non-Patent Literature

### Non-Patent Literature 1

Nucleic. Acids. Res., 31, page e60 (published in June, 2003)

### SUMMARY OF INVENTION

### Technical Problem

However, all of the above-described methods of evaluation and the like based on a value of fluorescence emitted from the fluorescent dye may have difficulties in realizing accurate evaluations. For example, the fluorescence value of the fluorescent dye varies depending on conditions such as a degree of drying and concentration of the fluorescent dye (reference literature: Second Edition of “Handbook of Instrumental Analysis”, Vol. 1, Kagaku Dojin, pp. 135-146, 1996). Therefore, a fluorescence value of a fluorescent dye in a solution state (before or soon after applied) cannot be simply compared with a fluorescence value of a fluorescent dye in a dried and aggregated spot. Thus, it was difficult to accurately quantify an absolute amount of trace DNAs or proteins contained in one spot by measurement of the fluorescence values.

In any of the conventional methods, relative comparison of the fluorescence values may realize evaluation of relative uniformity between spots in one batch with a certain degree of accuracy. However, as described previously, the conventional methods are not methods of measuring an absolute amount of DNAs or proteins in one spot. Therefore, the conventional methods have difficulties in comparing the fluorescence values in the cases including a case where the DNAs or proteins are immobilized in different ways and a case where the fluorescence values are measured under different conditions. Consequently, the conventional methods had the problem of the impossibility of evaluating relative uniformity between the spots in different batches.

Further, bleaching of the fluorescent dye decreases the fluorescence value, thus causing decrease in degree of accuracy of the measurement. This requires great care to be taken to prevent the spots to be measured from being exposed to outside light.

Still further, a base material of a chip on which DNAs or proteins are to be immobilized may show background fluorescence at intensity higher than that of the fluorescent dye. This caused the problem that the measurement of the fluorescence values required an expensive measurement system capable of eliminating background fluorescence, such as a confocal laser microscope.

The present invention has been attained in view of the above problems, and a main object of the present invention is to provide a novel method for estimating the amount of probes, such as nucleic acids or proteins, immobilized in a spot.

### Solution to Problem

The inventors of the present application diligently worked to solve the foregoing problems and accomplished the present invention by finding that an evaluation accuracy is improved by evaluation of the amount of probes contained in the spot based on the amount of particulate substances which are caused to coexist with the probes, and by measurement of the particle count, which is a discrete index, of the particulate substances, not by measurement of a signal (e.g. fluorescence value), which is a continuous index, emitted by the particulate substances.

Specifically, a method for estimating an amount of immobilized probes according to the present invention, comprises the successive steps of: providing a sample on a substrate to form one or more spots on the substrate, the sample containing particulate substances and probes in a predetermined ratio, the probes being reactive with a predetermined target; measuring the number of the particulate substances contained in at least one of the spots; and estimating the amount of the probes contained in the at least one of the spots from the thus measured number of the particulate substances.

Further, the present invention provides a probe immobilizing substrate comprising a substrate having one or more spots formed thereon, the spots containing particulate substances and probes in a predetermined ratio, the probes being reactive with a predetermined target.

Still further, the present invention provides a kit comprising: the probe immobilizing substrate; and a storage medium storing at least one of (i) the number of particulate substances contained in each of spots formed on the probe immobilizing substrate and (ii) an amount of probes contained in each of the spots, which amount has been estimated from the number of the particulate substances.

Yet further, the present invention provides a manufacturing apparatus for manufacturing a probe immobilizing substrate, the manufacturing apparatus comprising: an image capturing section for capturing an image of the probe immobilizing substrate; a particle count measuring section for analyzing the image of the probe immobilizing substrate having been obtained by the image capturing section, so as to measure the number of the particulate substances contained in each of the spots; a probe amount estimating section for estimating an amount of the probes contained in each of the spots from the number of the particulate substances having been measured by the particle count measuring section; and a quality evaluating section for evaluating a quality of the probe immobilizing substrate on a basis of the amount of immobilized probes having been estimated by the probe amount estimating section.

### Advantageous Effects of Invention

The present invention yields the effect of providing a novel method and the like by which the amount of immobilized probes, such as nucleic acids or proteins, in a spot can be estimated with a high degree of accuracy.

### BRIEF DESCRIPTION OF DRAWINGS

FIG. 1 is a view schematically showing the configuration of a manufacturing apparatus according to the present invention.

FIG. 2 is a view showing the states of fluorescence of a fluorescent dye (rhodamine B) and fluorescent beads before and after dried.

FIG. 3 is a graph showing comparison of a particle count of fluorescent beads and a fluorescence value of the fluorescent beads with respect to different concentrations of the fluorescent beads.

FIG. 4 is a graph showing a relation between the amount of fluorescent beads and the particle count of the fluorescent beads contained in a spot.

FIG. 5 is a view showing a procedure of an experiment in Example of the present invention.

FIG. 6 is a graph showing a correlation between the amount of capture antibodies (the amount of probes) and the amount of light emission in Example of the present invention.

FIG. 7 is a graph showing the results of correction of a measured value based on the amount of capture antibodies in one spot in Example of the present invention.

FIG. 8 is a view showing an example of a detectable particle size of the fluorescent beads in Example of the present invention.

FIG. 9 is a graph showing an example of the result of study on a density of the fluorescent beads and the number of fluorescent beads in one spot.

### DESCRIPTION OF EMBODIMENTS

### First Embodiment

(1) A Method for Estimating the Amount of Immobilized Probes

A method for estimating the amount of immobilized probes according to the present invention includes the successive steps of: providing a sample on a substrate to form one or more spots of the sample on the substrate, the sample containing particulate substances and probes in a predetermined ratio, the probes being reactive with a predetermined target (referred to as a step A); measuring the number of the particulate substances contained in at least one of the spots (referred to as a step B); and estimating the amount of the probes contained in the at least one of the spots from the thus measured number of the particulate substances (referred to as a step C).

(Probes and Target)

In the present invention, probes refer to substances that are reactive specifically with a predetermined target. Specific examples of the probes include: a nucleic acid sequence, such as DNA sequence or RNA sequence; a protein capable of specifically reacting to a predetermined target, such as an antigen, an antibody, a receptor protein or its fragments, a proteinous ligand or its fragments, or a lectin capable of binding specifically to a sugar chain; a bioactive compound such as a candidate pharmaceutical compound; and a specific ligand of an affinity tag such as avidin, streptavidin, glutathione, Ni-NTA, an anti-FLAG Tag® antibody, or amylose.

As the nucleic acid sequence, for example, a substance similar to a nucleic acid probe immobilized on a DNA chip or a RNA chip can be employed. The nucleic acid sequence may be single or double stranded, and may contain an artificial base in its sequence, if necessary. Further, the nucleic acid sequence may be modified if necessary. A length of the nucleic acid sequence is not particularly limited, but may be, for example, a length ranging from 20 bases to 300 k bases, preferably a length ranging from 25 bases to 60 bases. The term “bases” used as a measure of the length of the nucleic acid sequence is replaced by “mer” and “bp”, respectively, for the single-stranded nucleic acid sequence and the double-stranded nucleic acid sequence. In a case where the probe is a nucleic acid sequence, its target is, for example, a nucleic acid sequence substantially complementary to the probe, a protein capable of binding specifically to the probe, and the like.

As the protein used as the probe, for example, substances similar to a protein immobilized onto a protein chip, an immobilized antibody, an immobilized antigen, and an immobilized enzyme can be employed. The protein may contain an artificial amino acid in its amino acid sequence if necessary. Further, the protein may be modified if necessary. A length of amino acid sequences of the protein is not particularly limited. In a case where the protein is fragments, the length of amino acid sequence is, for example, a length ranging from 3 amino acid residues to 70 amino acid residues, preferably a length ranging from 8 amino acid residues to 25 amino acid residues. In a case where the probe is an antigen, its target is an antibody capable of binding specifically to the antigen. In a case where the probe is an antibody, its target is an antigen capable of binding specifically to the antibody. In a case where the probe is a receptor protein or its fragments, its target is a ligand specific to the receptor protein. In a case where the probe is a proteinous ligand or its fragments, its target is a receptor or its fragments capable of recognizing the probe.

As the bioactive compound serving as the probe, for example, substances similar to various low-molecular or high-molecular compounds immobilized on a compound chip can be employed. More specifically, the bioactive compound can be a candidate pharmaceutical compound, a candidate pesticide compound, a food additive, or others. In a case where the probe is the bioactive compound, its target is generally a protein, for example, an enzyme, a receptor protein, or others, an activity of which is controlled by the probe.

In a case where the probe is lectin, its target is a sugar chain or a glycolipid, or a cell having the sugar chain or the glycolipid on its surface.

In a case where the probe is a specific ligand of an affinity tag such as avidin or streptavidin, glutathione, Ni-NTA, an anti-FLAG Tag® antibody, or amylose, its target is a nucleic acid, a protein, or a ligand specifically labeled with an affinity tag such as biotin, glutathione-S-transferase, histidine Tag®, FLAGS peptide, or a maltose-binding protein, respectively. Further, in a case where the probe is a specific ligand of an affinity tag such as biotin, glutathione-S-transferase, histidine Tag®, FLAG® peptide, or a maltose-binding protein, its target is a nucleic acid, a protein, or a ligand specifically labeled with an affinity tag such as avidin or streptavidin, glutathione, Ni-NTA, an anti-FLAG Tag® antibody, or amylose.

(Particulate Substance)

In the present invention, the particulate substance refers to a wide range of particulate substances different from the probe. Specific examples of the particulate substance include non-fluorescent microbeads of various kinds and fluorescent particles. Among the above examples, fluorescent particles are more preferable, considering that the fluorescent particles can be counted under fluorescent observation. The particulate substances need to be the ones that can be counted, as detailed in the descriptions of the step B. Further, it is preferable that the particulate substance does not have a specific reactivity to the above-described probe and target. Still further, the particulate substances contained in a liquid are preferably the ones manufactured under the same standard (i.e. the ones substantially identical to one another).

The particulate substances may be of one type or plural types that are mutually recognizable and mixed in a predetermined ratio. In a case where the mixture of plural types of particulate substances is used, these particulate substances are mutually recognizable in particle size, fluorescence emitted, material, or the like feature.

The use of plural kinds of mutually recognizable particulate substances has, for example, the following advantages: 1) Choices of measurement devices that can be used for measurement of the number of particulate substances in the step B described later can be increased (for example, particulate substances a that can be measured by a measurement device a, particulate substances b that can be measured by a measurement device b, and particulate substances c that can be measured by a measurement device c are mixed for use.). 2) In a case where particulate substances of plural types and in different concentrations (for example, a high concentration of particulate substances A, a moderate concentration of particulate substances B, and a low concentration of particulate substances C) are previously mixed together with the probes, measurements of the number of particulate substances A, the number of particulate substances B, and the number of particulate substances C in the spot formed on the substrate can expand the range of the possibilities of measurement of the amount of probes, as compared with a case where particulate substances of one type are used.

A particle size (diameter) of the particulate substances is, for example, in a range from 30 nm (0.03 μm) to 100 μm, but is not particularly limited to this as long as they can be counted. Considering ease of counting, a particle size of the particulate substances is preferably not less than 0.5 μm, more preferably not less than 1 μm.

Further, a preferred range of particle size of the particulate substances can be specified in consideration of a relation with a diameter of the spot to be formed on the substrate. In a case where the diameter of the spot to be formed on the substrate ranges from several tens of microns to several hundred microns (i.e. in a range from 10 μm to less than 1000 μm), it is preferable to use particulate substances each having a particle size that ranges from 1/100 to 1/10 of the diameter of the spot. It is preferable to use particulate substances each having a particle size that ranges from 0.1 μm to 10 μm, which meets the above condition. It is more preferable to use particulate substances each having a particle size that ranges from 1 μm to 3 μm.

More preferably, the surfaces of the particulate substances are subjected to, for example, hytdrophilizing treatment or the like in order to prevent the particulate substances from aggregating. A specific example of the hytdrophilizing treatment includes introduction of a carboxyl group, a phosphate group, an amino group, a sulfone group, a hydroxyl group, a hydrophilic polymer, or others to the surfaces of the particulate substances.

The fluorescent particles used as the particulate substances are particles that emit fluorescence by irradiation of excitation light. Specific examples of the fluorescent particles include fluorescently labeled polymer, fluorescent latex particles, fluorescent silica particles, fluorescent polystyrene particles, fluorescent beads, and quantum dots (e.g. Qdot® manufactured by Quantum Dot Corporation). Particularly, fluorescent beads that are made by forming a synthetic polymer material with a fluorescent dye (polystyrene, latex, acrylic resin, or the like) in particle form are preferably used because the fluorescent beads change their fluorescence value in a relatively small amount when dried.

Specific examples of the fluorescent dye used for the fluorescent beads include fluorescein, rhodamine, phycobilin, acridine, coumarin, cyanine, Alexa Fluor® (Morecular Probes Co., Ltd.), CyDye® (GE Healthcare Japan Corporation), ruthenium (II) complex, and lanthanoid complex. Thus, various kinds of substances can be employed as the fluorescent dye.

Further, the non-fluorescent microbeads of various kinds used as the particulate substances are, for example, the above-described fluorescent particles but free from fluorescent dye. More specifically, examples of such fluorescent particles include latex particles, silica particles, and polystyrene particles. The non-fluorescent microbeads of various kinds may be colored by, for example, a coloring material that mainly absorbs light in a visible region, or may be clear and colorless.

Further, the particulate substances may be magnetized, for example, with magnetic particles or the like contained therein. If the particulate substances are magnetized, the particulate substances only can be easily removed from a probe immobilizing substrate by application of a magnetic field, if necessary.

(As to the Step A)

In the present invention, the step A is a step of providing on a substrate a sample (composition) containing the particulate substances and the probes in a predetermined ratio to form one or more spots of the sample on the substrate.

The sample containing the particulate substances and the probes in a predetermined ratio may be, for example, in a liquid form, in a paste form, in a solid form (e.g. in powder form), or in other form. The form of the sample is not particularly limited. However, the sample is preferably in a liquid form because the particulate substances and the probes are more easily dispersed uniformly over the sample in a liquid form. The scope of the liquid form encompasses a sol (solution before gelation) containing the particulate substances and the probes.

Further, as an example of a method of uniformly dispersing the particulate substances over the sample in paste or a solid form, given is a method of uniformly mixing the particulate substances and a solution containing the probes with each other, after which the resulting mixture sample is subjected to temperature treatment (heating or cooling) or chemical treatment so as to be changed to a paste or solid form.

In a case where the sample is a liquid sample containing the particulate substances and the probes in a predetermined ratio, the order in which the particulate substances and the probes are mixed into a liquid and other conditions involved in the preparation of the liquid sample are not particularly limited. Specific examples of a method of preparing the liquid sample may be as follows. 1) A high concentration of solution containing the probes in a predetermined concentration is diluted with the liquid, after which the resulting solution is mixed with the particulate substances. 2) A high concentration of solution containing the probes in a predetermined concentration is diluted with the liquid containing the particulate substances in a predetermined amount. Either of the examples may be employed as long as a direct correlation is shown between respective final amounts of probes and particulate substances contained in the liquid sample.

The liquid used in the step A is desired to be unreactive to the probes and the particulate substances. Specifically, preferable examples of the liquid include water (pure water), physiological saline, various buffer solutions including phosphate buffer solution and tris buffer solution, and organic solvents including methanol, ethanol, and propanol. In addition, a reagent except for the probes and the particulate substances, e.g. any of reagents for stabilizing the probes or the particulate substances or promoting detection reaction, such as sodium chloride, ethylenediaminetetraacetic acid, a protease inhibitor, glycine, betaine, proline, glycerol, trehalose, sucrose, and polyethyleneglycol, may be added to the above liquid.

The number of particulate substances contained in a unit amount of the liquid may be determined as appropriate depending on a particle size of the particulate substance, the type of the particulate substance, etc. Specifically, for example, an upper limit of the number of particulate substances is determined so that the particulate substances are contained at a density of not more than 300 in a 100 square micrometer area of the spot formed on the substrate. The particulate substances are contained preferably at a density of not more than 35 in a 100 square micrometer area of the spot, more preferably not more than 30 in a 100 square micrometer area of the spot, further preferably not more than 25 in a 100 square micrometer area of the spot. Determination of the upper limit of the number of particulate substances in the above-described range has an advantage of enabling easy recognition of different types of particulate substances with a higher degree of reliability in the later-described step B. A lower limit of the particulate substances is not particularly limited. However, the particulate substances are contained preferably at a density of not less than 100 per spot formed on the substrate in order to obtain a measurement result with a higher degree of accuracy.

The amount of probes contained in a unit amount of the liquid may be determined as appropriate in accordance with reaction conditions and a degree of detection sensitivity in detecting the probes in an array of spots containing the probes on the substrate. The amount of probes contained in a unit amount of the liquid is, but is not particularly limited to, an amount ranging from 18 μg/mL to 800 μg/mL, in a case where the probes are proteins.

For the improvement of accuracy in measurement, it is preferable that the particulate substances and the probes are dispersed in the liquid as uniformly as possible. For this purpose, an operation such as stirring the liquid containing the particulate substances and the probes may be performed, if necessary.

Further, in a case where the sample containing the particulate substances and the probes in a predetermined ratio is a liquid, spots of the liquid may be dried before the process goes to the later-described step B.

The type of the substrate on which the sample (preferably, liquid) containing the particulate substances and the probes in a predetermined ratio is to be provided is not particularly limited. Specific examples of the substrate include a glass substrate, a plastic substrate, a silicon substrate (Si substrate, SiC substrate, etc.), and a substrate, such as a nitrocellulose film, for use as a DNA chip, a protein chip, and a compound chip. Any of these may be employed as the substrate. The shape of the substrate is not particularly limited. Specific examples of the shape include a flat shape (i.e. plate) and a microfluidic chip shape.

A method of providing the sample (preferably, liquid) on the substrate (i.e. an application method) is not particularly limited. Specific examples of the method include mechanical spotting, inkjet printing, microcontact printing, and electrospray deposition (ESD). However, the ESD is preferable because it realizes formation of spots with excellent uniformity and reproducibility. Note that the use of the ESD requires a conductive layer, such as an ITO (indium tin oxide) thin film, on the substrate side.

The spots of the sample (preferably, liquid) may be formed by 1) applying the sample in spots on the substrate or 2) providing the sample in a predetermined pattern on the substrate, and then forming the spots at intersections of the pattern of the sample provided on the substrate and channels provided to cross the pattern of the sample. For example, the spots may be formed in such a way that the sample may be provided in a pattern of plural parallel thin lines on the substrate, and the spots are formed at intersections of the pattern of the sample and a plurality of channels provided to cross the pattern of the sample.

In the step A, a plurality of spots of the sample are formed on a spot-forming surface of the substrate. The shape (circular shape, square shape, etc.), size (diameter, area, etc.), a density, and other conditions of the spots to be formed are not particularly limited. However, an area of the spot is preferably in a range from 7.85×10⁻⁵ mm² to 78.5 mm², more preferably in a range from 0.07 mm² to 0.375 mm². This is because the decrease of the spots in size increases the susceptibility to nonuniforminty of an amount of immobilized probes. Further, the density of the spots in a unit area on the substrate is preferably in a range from 1 to 10⁶ spots per square centimeter, more preferably in a range from 1 to 2000 spots per square centimeter.

(As to the Step B)

The step B is a step performed subsequent to the step A, and the step B is a step of measuring the number of particulate substances contained in at least one of the spots, preferably each of the spots, having been formed in the step A.

In a case where the particulate substances are the above-described fluorescent particles, fluorescence emitted by the fluorescent particles when exposed to excitation light is observed. For the observation, for example, a fluorescence microscope with an optical resolving power that enables recognition of the individual fluorescent particles, or a fluorescence scanner is used. That is, one of the features in the step B is measurement of the number of discrete particles, not measurement of the fluorescence value (the amount of fluorescence) that is a continuous amount used in the conventional measurement.

Further, in a case where the particulate substances are the non-fluorescent microbeads of various kinds, any optical detection method can be used appropriate to properties of the microbeads. For example, the particulate substances can be detected: by observations under various microscopes such as a transmission microscope, a phase contrast microscope, a differential interference microscope, a polarizing microscope, and a dark field microscope; or by observation of a phenomenon in which light except for fluorescence is emitted. Note that the fluorescent particles may be detected by these exemplified methods.

In a case where a color different from a color of the substrate (background) is applied to the non-fluorescent microbeads of various kinds by a dye material (except for a fluorescent dye material), it is safe that an image of the spots is obtained by use of an optical microscope with an optical resolving power that enables recognition of the individual microbeads, and the number of microbeads are then counted by analysis of the obtained image.

Counting the number of particulate substances may be carried out by visual observation. However, a method of obtaining the image of the spots and then counting the number of microbeads in one spot by software-based analysis of the image is more preferably employed because its operation is easy. A specific example of software used in the image analysis includes ImageJ (see Examples).

(As to the Step C)

The step C is a step performed subsequent to the step B, and the step C is a step of estimating the amount of probes contained in the spot(s) from the number of particulate substances having been measured in the step B.

As explained in the descriptions of the step A, a ratio between the number of particulate substances contained in the liquid and the amount of probes is a known ratio (a predetermined ratio). Thus, from the number of particulate substances having been measured in the step B, i.e. the number of particulate substances contained in at least one of the spots, preferably each of the spots, it is possible to find the amount of probes (absolute amount) applied in the spot(s).

For example, assume that a liquid containing approximately 100 particulate substances and approximately ng of probes in a unit amount is applied onto the substrate so that a plurality of spots are formed on the substrate. In this case, if 50 particulate substances are counted in the spot(s), it can be estimated that 0.5 ng of probes are immobilized in the spot(s).

Alternatively, in the step C, relative amounts of immobilized probes in the spots as targets for comparison may be found. For example, assume that 50 particulate substances are counted in a first spot, and 75 particulate substances are counted in a second spot. In this case, it can be estimated that the amount of probes immobilized in the second spot is 1.5 times (75/50) the amount of probes immobilized in the first spot.

(2) Probe Immobilizing Substrate and Kit

Through the steps A through C, one or more spots containing the particulate substances such as fluorescent beads and the probes in a predetermined ratio are formed on the substrate, which thus manufactures a probe immobilizing substrate of the present invention. Specific examples of the probe immobilizing substrate include: a nucleic acid chip (nucleic acid microarray, etc.) such as a DNA chip or a RNA chip; a protein chip (protein microarray); a compound chip having a bioactive compound provided thereon; a lectin chip; a specific probe chip of an affinity tag (avidin, glutathione, etc.); and a microfluidic chip having a nucleic acid, a protein, a bioactive compound, lectin, or a specific probe of an affinity tag provided thereon.

Further, a kit of the present invention includes: 1) the probe immobilizing substrate; and 2) a storage medium storing at least one of (i) information on the number of particulate substances that are contained in each of the spots formed on the probe immobilizing substrate and (ii) information on an estimated amount of probes contained in each of the spots from the number of particulate substances.

The type of the storage medium is not particularly limited. Specific examples of the storage medium include: a print medium, a Floppy® disk, and a CD-ROM. However, the storage medium is preferably a storage medium that can be dealt with by an information processor such as a computer. The information stored in the storage medium is used, for example, to execute “(6) A method for correcting the amount of reacting targets”, which will be described later.

Further, a kit of the present invention may include particulate substance removing means for removing the particulate substance from the probe immobilizing substrate, such as a magnet or a compressed gas spray. In a case where the particulate substances show are magnetized, it is possible to remove only the particulate substances by use of a magnet. Alternatively, for example, mechanical vibrations may be applied to the probe immobilizing substrate by beating of the probe immobilizing substrate or the like method, so that the particulate substances only can be removed. Further alternatively, the particulate substances only may be blown out by compressed gas (compressed air, etc.) through the use of a compressed gas spray.

(3) A Method for Inspecting the Quality of the Probe Immobilizing Substrate and an Apparatus for Manufacturing the Probe Immobilizing Substrate

A method for inspecting the quality of a substrate according to the present invention includes a step of evaluating uniformity of the amount of immobilized probes from spot to spot on one probe immobilizing substrate. More specifically, the amount of immobilized probes in two or more spots on one probe immobilizing substrate is estimated by the method described in “(1) the method for estimating the amount of immobilized probes” section. Next, by using the estimated amount of immobilized probes, dispersion in the amount of immobilized probes from spot to spot is measured (i.e. the uniformity is evaluated).

Preferably, the method further includes a step of determining if the dispersion falls within a predetermined range. In the step, the probe immobilizing substrate is judged as a conforming product if the dispersion falls within the predetermined range and judged as a nonconforming product if the dispersion falls outside the predetermined range. Note that a criterion of the go/no-go judgment on the probe immobilizing substrate may be determined as appropriate according to, for example, the usage of the probe immobilizing substrate.

Further, an apparatus for manufacturing a probe immobilizing substrate according to the present invention (serving as a quality inspecting apparatus) includes an image capturing section, a particle count measuring section, a probe amount estimating section, and a quality evaluating section.

The image capturing section captures an image of the probe immobilizing substrate, on which one or more spots containing the particulate substances and the probes in a predetermined ratio are formed, and then performs imaging of the one or more spots. Specifically, the image capturing section is realized by: for example, various microscopes (fluorescence microscope, etc.) capable of observing the particulate substances and having an image capturing function; or scanners (fluorescence scanner, etc.) appropriate to properties of the particulate substances.

The particle count measuring section analyzes the image of the probe immobilizing substrate which image has been obtained by the image capturing section, so as to measure the number of particulate substances contained in each of the spots. Specific examples of the particle count measuring section include an information processor having the above-described image analysis software (ImageJ, etc.) installed thereon.

The probe amount estimating section estimates the amount of probes contained in each of the spots from the number of particulate substances having been measured by the particle count measuring section. Specific examples of the probe amount estimating section include the same information processor as the one used as the particle count measuring section. More specifically, by using an information processor or the like on which information on quantitative relations between the probes and the particulate substances is installed or an information processor or the like having memory that stores such information therein, it is possible to estimate the amount of probes contained in each of the spots (absolute amount). Alternatively, by comparing of the number of particulate substances between the spots by means of the information processor or the like, it is possible to estimate relative amounts of immobilized probes in the spots as targets for comparison.

The quality evaluating section evaluates the quality of the probe immobilizing substrate in accordance with the amount of immobilized probes contained in each of the spots, which amount has been estimated by the probe amount estimating section. Examples of the quality evaluating section include the same information processor as the one used as the particle count measuring section. A criterion of the go/no-go judgment on the probe immobilizing substrate may be determined as appropriate according to, for example, the usage of the probe immobilizing substrate. The following will take an example of the criterion of the go/no-go judgment. That is, it is determined if the dispersion in the amount of immobilized probes from spot to spot falls within a predetermined range, and the probe immobilizing substrate is judged as a conforming product if the dispersion falls within the predetermined range and judged as a nonconforming product if the dispersion falls outside the predetermined range.

For descriptions on the operations of the image capturing section and the particle count measuring section, the descriptions of the step B in “(1) A method for estimating the amount of immobilized probes” section can be referred to. For descriptions on the operation of the probe amount estimating section, the descriptions of the step C in Section (1) above can be referred to.

The apparatus for manufacturing the probe immobilizing substrate according to the present invention may further include spot forming means or spot modifying means, which will be described later, preferably both the spot forming means and the spot modifying means.

The spot forming means is means for providing on the substrate the sample containing the probes and the particulate substances in a predetermined ratio to form spots of the sample. The probe immobilizing substrate having been manufactured by the spot forming means is then subjected to image capturing through the image capturing section. For descriptions on the operations of the spot forming means, the descriptions of the step A in “(1) A method for estimating the amount of immobilized probes” section can be also referred to.

The spot modifying means is means for modifying a spot formed on the probe immobilizing substrate that has been judged as an unconforming product by the quality evaluating section. That is, the spot modifying means provides a spot having a shortage of the immobilized probes with probes by an amount equivalent to the shortfall so as to modify the amount of immobilized probes in the spot. For descriptions on the operations of the spot modifying means, the descriptions in “(4) (A) A method for manufacturing the probe immobilizing substrate or a method for modifying the spot” section and “(5) (B) A method for manufacturing the probe immobilizing substrate or a method for modifying the spot” section can be also referred to.

As the spot forming means and the spot modifying means, a pattern forming device capable of forming a pattern (spots, etc.) of the sample can be used by mechanical spotting, inkjet printing, microcontact printing, or ESD. Particularly, an ESD device is more preferably used.

The following will describe an example of a manufacturing apparatus of the present invention with reference to FIG. 1. As schematically shown in FIG. 1, a manufacturing apparatus 10 includes: a robot arm (substrate carrying section) 2; a microscope device (image capturing section) 5; a plate storage stacker 3; an XY stage (substrate observation stage) 4; a selected plate storage stacker 6; and a computer (control device, particle count measuring section, probe amount estimating section, quality evaluating section) 1.

In the case where the particulate substances are fluorescent particles, the microscope device 5 is a fluorescence microscope having optical resolving power that enables recognition of the fluorescent particles. The microscope device 5 includes: a light source device 8 capable of switching between white light and excitation light; and a CCD camera (image capturing means, not shown), as part of the components.

The robot arm 2 carries a probe immobilizing plate (probe immobilizing substrate) 7 from the plate storage stacker 3 to the XY stage 4, and carries the probe immobilizing plate from the XY stage 4 to the selected plate storage stacker 6. As the substrate carrying section, the robot arm 2 may be replaced by a belt conveyer. However, the configuration of the manufacturing apparatus 10 shown in FIG. 1 is more excellent for the measurement of the number of particulate substances in the fine spot with a higher degree of accuracy.

The XY stage 4 moves the probe immobilizing plate 7 mounted thereon in two horizontal directions. This enables observation of the entire plate 7 through the use of the microscope device 5. In a case where the probe immobilizing plate 7 is relatively small, or in a case where the microscope device 5 is replaced by a fluorescence scanner, the XY stage 4 may be replaced by a fixing stage.

In the manufacturing apparatus 10, the computer 1 automatically controls the operations of all of the robot arm 2, the microscope device 5, the plate storage stacker 3, the XY stage 4, and the selected plate storage stacker 6. That is, it is possible to realize automated quality inspection of the probe immobilizing substrate through the use of the manufacturing apparatus 10.

(4) (A) A Method for Manufacturing the Probe Immobilizing Substrate or a Method for Modifying the Spot

An example of the method for manufacturing the probe immobilizing substrate or the method for modifying the spot according to the present invention, includes the successive steps of: evaluating uniformity of the amount of immobilized probes from spot to spot on one probe immobilizing substrate; and providing the probes to a spot having a shortage of probes to equalize the amount of immobilized probes from spot to spot.

More specifically, in the method for manufacturing the probe immobilizing substrate or the method for modifying the spot according to the present invention, the amount of immobilized probes contained in two or more spots on one probe immobilizing substrate is estimated by using the above-described method in “(1) A method for estimating the amount of immobilized probes” section (“amount-of-immobilized-probes estimating step”). Then, uniformity of the amount of immobilized probes is evaluated from spot to spot on the basis of the amount of immobilized probes thus estimated (“uniformity evaluating step”). Further, the probes are provided to a spot having a shortage of probes so that the amount of immobilized probes is equalized from spot to spot (ununiformity eliminating step).

In the amount-of-immobilized-probes estimating step, (i) information on the estimated amount of immobilized probes in each of the spots and (ii) information on the location of the spot on the substrate are obtained in sets. When these information items are provided in the uniformity evaluating step, ununiformity information on the extent to which the amount of immobilized probes of one spot in a predetermined location on the substrate is large/small as compared with another spot in another location is obtained.

In the ununiformity eliminating step, supplementary probes are fed (added) to, for example, only a spot having immobilized probes in an amount smaller than an allowable limit of ununiformity among the spots formed on the substrate. This enables ununiformity of the amount of immobilized probes from spot to spot to fall within the allowable limit. In the ununiformity eliminating step, specific examples of a method of feeding the probes to the spot include mechanical spotting, inkjet printing, microcontact printing, and ESD. However, the ESD is preferably used because it enables application of the probes in dry powder form and does not require dissolution of the spot.

The probe immobilizing substrate manufactured in this manner is used for reaction with a target that reacts specifically with the probes in a biochemical test and the like, for example. Through the use of the probe immobilizing substrate, in which the amount of immobilized probes in each of the spots fall within the allowable limit of ununiformity, it is possible to obtain an accurate result of the biochemical test and the like.

(5) (B) A Method for Manufacturing the Probe Immobilizing Substrate or a Method for Modifying the Spot (B)

In another example of the method for manufacturing the probe immobilizing substrate or the method for modifying the spot according to the present invention, the amount of immobilized probes contained in at least one of the spots, preferably in each of the spots on one probe immobilizing substrate is estimated by using the above-described method in “(1) A method for estimating the amount of immobilized probes” section (“amount-of-immobilized-probes estimating step”). Then, a difference between an expected value of the amount of probes to be immobilized in the spot and the amount of immobilized probes (the estimated value) is detected (“difference obtaining step”). Further, probes are provided to a spot having a shortage of probes so that the difference from the expected value is eliminated (“difference eliminating step”).

In the amount-of-immobilized-probes estimating step, (i) information on the estimated amount of immobilized probes in each of the spots and (ii) information on the location of the spot on the substrate are obtained in sets. When these information items are provided in the difference obtaining step, difference information on the extent to which the amount of immobilized probes of each spot in a predetermined location on the substrate is large/small as compared with the expected value of the amount of immobilized probes.

In the difference eliminating step, supplementary probes are fed (added) to, for example, only a spot having immobilized probes in an amount smaller than the expected value among the spots formed on the substrate. This makes it possible to bring the amount of immobilized probes in each spot close to the expected value.

In the difference eliminating step, specific examples of a method of feeding the probes to the spot include mechanical spotting, inkjet printing, microcontact printing, and ESD. However, the ESD is preferably used because it enables application of the probes in dry powder form and does not require dissolution of the spot.

The probe immobilizing substrate manufactured in this manner is used for reaction with a target that reacts specifically with the probes in a biochemical test and the like, for example. Through the use of the probe immobilizing substrate, in which the amount of immobilized probes in each of the spots fall is almost the same as the expected value, it is possible to obtain an accurate result of the biochemical test and the like.

(6) A Method for Correcting the Amount of Reacting Targets

In the above sections (4) and (5), the method for modifying each of the spots by addition of probes on the probe immobilizing substrate has been described. However, correction may be made to data obtained after reaction of the probe immobilizing substrate with the targets, as described below.

More specifically, in the method for correcting the amount of reacting targets according to the present invention, the amount of immobilized probes in at least one spot on the probe immobilizing substrate is estimated with reference to the above-described method in “(1) A method for estimating the amount of immobilized probes” section. Then, the targets are reacted with the probe immobilizing substrate so that a value of the amount of targets having reacted with the probes is obtained for each spot. Subsequently, spot-by-spot correction is made to the obtained value of the amount of reacting targets, in accordance with the estimated amount of immobilized probes.

In the step of correcting the value of the amount of targets, spot-by-spot correction is made, for example, in the following manner. That is, the value of the amount of reacting targets is divided by the amount of immobilized probes (estimated amount), and a result of the division is assumed to be a corrected value of the amount of reacting targets. With such correction, it is possible to compare the amounts of targets between the respective spots on the basis of a unit amount of probes. This further improves an accuracy of measurement.

The method for correcting the amount of reacting targets is applicable to correction of measured values for the respective spots in one probe immobilizing substrate, and the method is further applicable to correction of measured values for the respective probe immobilizing substrates.

Further, information stored in the storage medium included in the kit described in “(2) Probe immobilizing substrate and kit” section above can be used for correction of the amount of targets reacted.

As described above, a method for estimating the amount of immobilized probes according to the present invention includes the successive steps of: providing a sample on a substrate to form one or more spots on the substrate, the sample containing particulate substances and probes in a predetermined ratio, the probes being reactive with a predetermined target; measuring the number of the particulate substances contained in at least one of the spots; and estimating the amount of the probes contained in the at least one of the spots from the thus measured number of the particulate substances.

A method for estimating the amount of immobilized probes according to the present invention is more preferably such that the particulate substances are fluorescent beads. This is because no substantial changes in fluorescence value of the fluorescent beads occur even when the fluorescent beads are dried upon application to the substrate. Moreover, in the present invention, the number of fluorescent beads is detected. This brings about the following benefits. 1) It is sufficiently possible to detect the number of fluorescent beads as long as the fluorescence value of the fluorescent beads is higher than that of the background. 2) Since the fluorescent beads can be easily separated from the background without confocal laser microscope or the like, the measurement of the number of fluorescent beads is possible with use of a relatively inexpensive measurement device as compared with the measurement of the fluorescence value. 3) The measurement result is less susceptible to bleaching of fluorescence due to exposure to outside light or change in intensity of excitation light.

A method for estimating the amount of immobilized probes according to the present invention is preferably such that each of the particulate substances has a particle size in a range from 1 μm to 3 μm, considering ease of counting the number of particles.

A method for estimating the amount of immobilized probes according to the present invention is preferably such that such conditions that the particulate substances are contained at a density of not more than 30 particulate substances in a 100 square micrometer area of each of the spots, and that the number of the particulate substances contained per spot is not less than 100 are satisfied, considering further improvement of an estimation accuracy. Note that the wording “each of the spots” refers to a single spot if there is only one spot as a target for measurement of the number of particulate substances.

A method for estimating the amount of immobilized probes according to the present invention may be such that the probes are of at least one type selected from a group consisting of nucleic acid sequences, proteins, and specific ligands of affinity tags.

A method for estimating the amount of immobilized probes according to the present invention may be such that the spots are formed on the substrate as intersections of a pattern of the sample provided on the substrate and channels provided to cross the pattern of the sample. For example, the spots correspond to intersections or the like of (i) a linear pattern of the sample fixed on a plate of a microfluidic chip (microchannel chip) and (ii) microchannels crossing the linear pattern.

A method for estimating the amount of immobilized probes according to the present invention is preferably such that the sample is a liquid containing the particulate substances and the probes in a predetermined ratio.

Further, the present invention provides a method for inspecting a quality of a substrate having probes immobilized thereon, comprising the step of: estimating an amount of immobilized probes contained in two or more spots by the method for estimating the amount of immobilized probes, and then evaluating uniformity of the amount of immobilized probes from spot to spot.

Still further, the present invention provides (A) a method for manufacturing a substrate having probes immobilized thereon, comprising the successive steps of: estimating an amount of immobilized probes contained in two or more spots by the method for estimating the amount of immobilized probes, and then evaluating uniformity of the amount of immobilized probes from spot to spot; and providing the probes to a spot having a shortage of probes to equalize the amount of immobilized probes from spot to spot.

The manufacturing method (A) is preferably such that the step of equalizing the amount of immobilized probes is performed by providing the probes by ESD.

Yet further, the present invention further provides (B) a method for manufacturing a substrate having probes immobilized thereon, comprising the successive steps of: estimating an amount of immobilized probes contained in at least one of spots by the method for estimating the amount of immobilized probes, and then detecting a difference between the thus estimated amount of immobilized probes and an expected value of the amount of probes to be immobilized in the spot; and providing the probes to a spot having a shortage of probes to eliminate the difference from the expected value.

The manufacturing method (B) is preferably such that the step of eliminating the difference from the expected value is performed by providing the probes by ESD.

Further, the present invention provides a probe immobilizing substrate constituted by a substrate having one or more spots formed thereon, the spots containing particulate substances and probes in a predetermined ratio, the probes being reactive with a predetermined target.

Still further, the present invention provides a kit comprising: the probe immobilizing substrate; and a storage medium storing at least one of (i) the number of particulate substances contained in each of spots formed on the probe immobilizing substrate and (ii) an amount of probes contained in each of the spots, which amount has been estimated from the number of the particulate substances. Note that the wording “each of the spots” refers to a single spot if only one spot is formed on the probe immobilizing substrate of the kit.

Yet further, the present invention provides a method for correcting an amount of reacting targets, comprising the successive steps of: estimating an amount of immobilized probes contained in at least one spot on a probe immobilizing substrate by a method according to claim 1, the probe immobilizing substrate comprising a substrate having one or more spots formed thereon, the spots containing particulate substances and probes in a predetermined ratio, the probes being reactive with a predetermined target; causing the probe immobilizing substrate to be reacted with the target being reactive with the probes, so as to obtain a value of an amount of target having reacted with the probes; and correcting the thus obtained value of the amount of target on a basis of the thus estimated amount of immobilized probes.

Further, the present invention provides a manufacturing apparatus for manufacturing a probe immobilizing substrate, the manufacturing apparatus comprising: an image capturing section for capturing an image of the probe immobilizing substrate; a particle count measuring section for analyzing the image of the probe immobilizing substrate having been obtained by the image capturing section, so as to measure the number of the particulate substances contained in each of the spots; a probe amount estimating section for estimating an amount of the probes contained in each of the spots from the number of the particulate substances having been measured by the particle count measuring section; and a quality evaluating section for evaluating a quality of the probe immobilizing substrate on a basis of the amount of immobilized probes having been estimated by the probe amount estimating section. As to the above manufacturing apparatus, the wording “each of the spots” refers to a single spot if one spot is formed on the probe immobilizing substrate.

The manufacturing apparatus according to the present invention may comprise at least one of the following means: spot forming means for manufacturing the probe immobilizing substrate whose image is to be captured by the image capturing section; and spot modifying means for modifying a spot formed on a probe immobilizing substrate which has been judged as a nonconforming product by the quality evaluating section.

### EXAMPLES

The following will specifically describe the present invention by way of Reference Examples and Example.

### Reference Example 1

### Change in Fluorescence Due to Drying

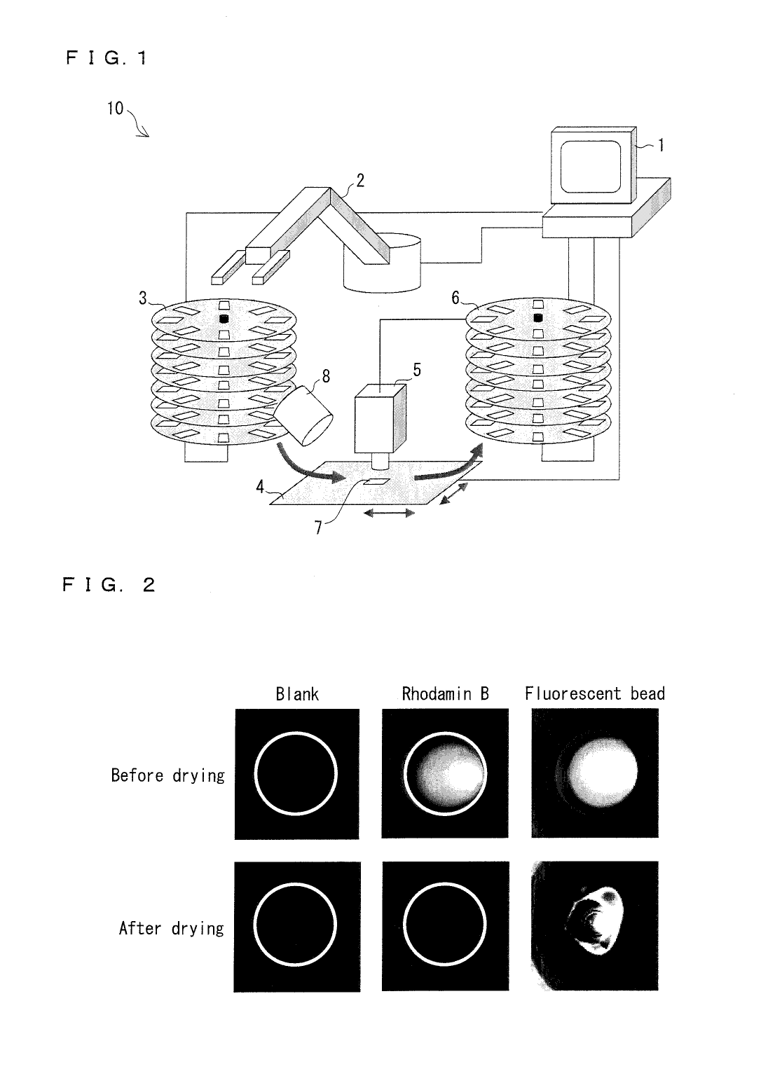

One μL of an aqueous solution containing rhodamine B (Wako) (75 μg/mL), 1 μL of water containing 0.25% by weight of fluorescent beads (Latex beads, carboxylate-modified polystyrene, fluorescent yellow-green (mean particle size of 0.03 μm, aqueous suspension) manufactured by Sigma-Aldrich Corporation), and 1 μL of blank (water) were respectively dropped into wells of a 96-well plate, after which fluorescence observation of spots formed in the wells was made under a fluorescence microscope (BX51 WI) manufactured by Olympus Corporation. Then, the spots were allowed to stand until dried, after which fluorescence observation of the spots was made again. As shown in FIG. 2, the results of the fluorescence observation were as follows. In the case of rhodamine B, a remarkable fluorescence decrease caused by drying was observed. On the other hand, in the case of the fluorescent beads, sufficient fluorescence was observed even in the dried state. From these results, the following is considered. That is, in a case where a mixture of rhodamine B and probes is dropped, a fluorescence value significantly decreases due to drying of rhodamine B, and it would therefore be difficult to accurately estimate the amount of dropped probes from the fluorescence value. However, in the case of the fluorescent beads, a remarkable decrease of the fluorescence value was not shown even when the fluorescent beads were dried, and the fluorescent beads could be counted. From this result, it was found that the fluorescent beads could be used for estimation of the amount of probes.

### Reference Example 2

### Comparison of the Fluorescence Value and the Particle Count with Respect to Concentrations of the Fluorescent Beads

A polydimethylsiloxane (PDMS) microchannel with 16 fine channels each having a width of 250 μm and a depth of 115 μm was prepared. Then, fluorescent beads (Latex beads, carboxylate-modified polystyrene, fluorescent orange (mean particle size of 1 μm, aqueous suspension) manufactured by Sigma-Aldrich Corporation) were diluted with water to prepare five dilute aqueous suspensions. The five dilute aqueous suspensions thus prepared decreased in turn in concentration by a factor of 10 and are in concentrations from 250 ng/mL to 2500 μg/mL. The five dilute aqueous suspensions of the fluorescent beads in five concentrations were each injected into three channels of the microchannel through a microfluidic chip-use liquid delivery device (manufactured by Fuence Co., Ltd.). Into one remaining channel, water was poured as a blank.

Then, using a 1×-magnification fluorescence microscope (BX-51 WI, manufactured by Olympus Corporation) connected to a cooled CCD camera (ORCAII, manufactured by Hamamatsu Photonics KK), a fluorescent image of the microchannel was photographed. As a fluorescence filter, a fluorescence filter (XF102-2, manufactured by Omega Optical, Inc.) was used.

The fluorescent image thus obtained was analyzed by using ImageJ (reference literature: Biophotonics International, vol. 11, pp. 36-42, 2004). Specifically, an average pixel intensity value of a 250 μm-wide and 750 μm-long area (capacity of approximately 22 nL) of the microchannel in the fluorescent image was calculated, and a pixel intensity value of the blank was subtracted from the average value to find a fluorescence value at each concentration of the fluorescent beads.

Further, a fluorescent image of the microchannel was photographed in the same manner under the fluorescence microscope at a 5× magnification. Then, by using ImageJ, the particle count of the fluorescent beads present in the 250 μm-wide and 750 μm-long area was measured in the same manner.

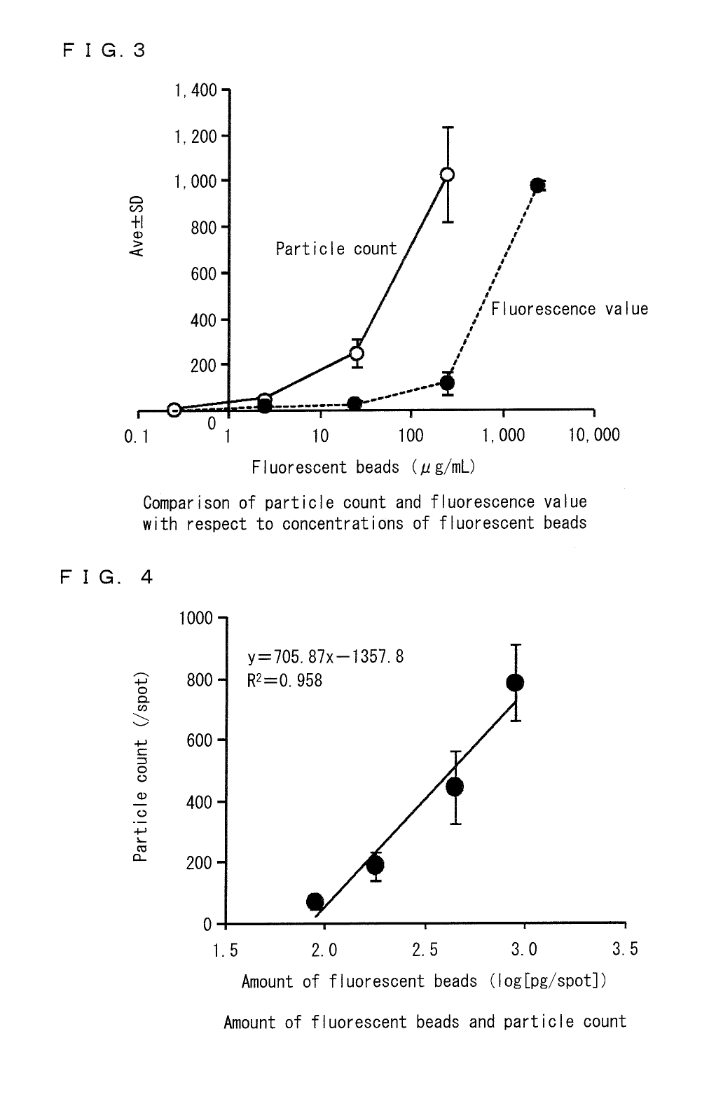

Then, an average value and a standard deviation of the fluorescence values and the particle counts were calculated for each group of three channels into which the five dilute aqueous suspensions were each injected. As shown in FIG. 3, the results showed that detection based on the fluorescence value was possible at a concentration of not less than 250 μg/mL (about 5,500 pg per grid), whereas detection based on the particle count was possible at a concentration of not less than 2.5 μg/mL (55 pg). This indicates that in a case where the fluorescent beads are used, sensitivity for observation based on the particle count is about 100 times higher than sensitivity for observation based on the fluorescence value.

### Reference Example 3

### Correlation Between the Amount of Fluorescent Beads and the Particle Count

Using an electrospray device (ES-3200, manufactured by Fuence Co., Ltd.), the fluorescent beads (see Reference Example 2) uniformly sprayed by ESD in a pattern of thin lines each approximately 750 μm in width and 14 mm in length on a 26 mm-wide, 76 mm-long, 1.1 mm-thick ITO-coated slide glass (ITO glass, manufactured by Opton Japan Co., Ltd.). This thin line pattern has four lines respectively containing 5 ng, 10 ng, 20 ng, and 40 ng of fluorescent beads.

Next, the PDMS microchannel (see Reference Example 2) was placed so as to intersect the thin line pattern, and the number of fluorescent beads in one spot (250 μm in width, 750 μm in length), which is an intersection where each channel crosses each thin line, was measured. The amount of fluorescent beads in one spot is approximately 90 pg to 900 pg. As in the Reference Example 2, an average value and a standard deviation of the particle count of the fluorescent beads in 16 spots formed in each thin line were calculated. The result of the calculation is shown in FIG. 4.

The result showed a correlation between the amount of fluorescent beads and the particle count of the fluorescent beads was as high as R²=0.958. From a regression line, the number of fluorescent beads per picogram was found to be approximately 1.3. This indicates that the amount of electro-sprayed fluorescent beads can be calculated from the particle count in one spot, and that the amount of sample (probes) in the spot can be, in turn, calculated from a ratio of the amount of fluorescent beads to the amount of sample (probes), such as DNAs or proteins, to be applied.

### Example 1

### Measurement of the Amount of Proteins (Probes) in a Spot Through Use of the Fluorescent Beads

To 90.4 μg/mL of anti-mouse interleukin-2 (IL-2) capture antibodies (eBioscience) which had been desalted with pure water, the fluorescent beads (see Reference Example 2) was added. The resultant suspension was of a final beads concentration of 29.0 μg/mL (approximately 3.77×10⁴ beads/mL from Reference Example 3). Using the electrospray device (ES-3200), the resultant suspension was uniformly sprayed in a pattern of thin lines each approximately 750 μm in width and 14 mm in length on the ITO glass so that the lines contain the suspension in amounts of 86.3 nL, 173 nL, 345 nL, 690 nL, and 1,380 nL, respectively. On the ITO glass, the PDMS microchannel (see Reference Example 2) was set so as to intersect the thin line pattern. As a result, a microfluidic chip was prepared.

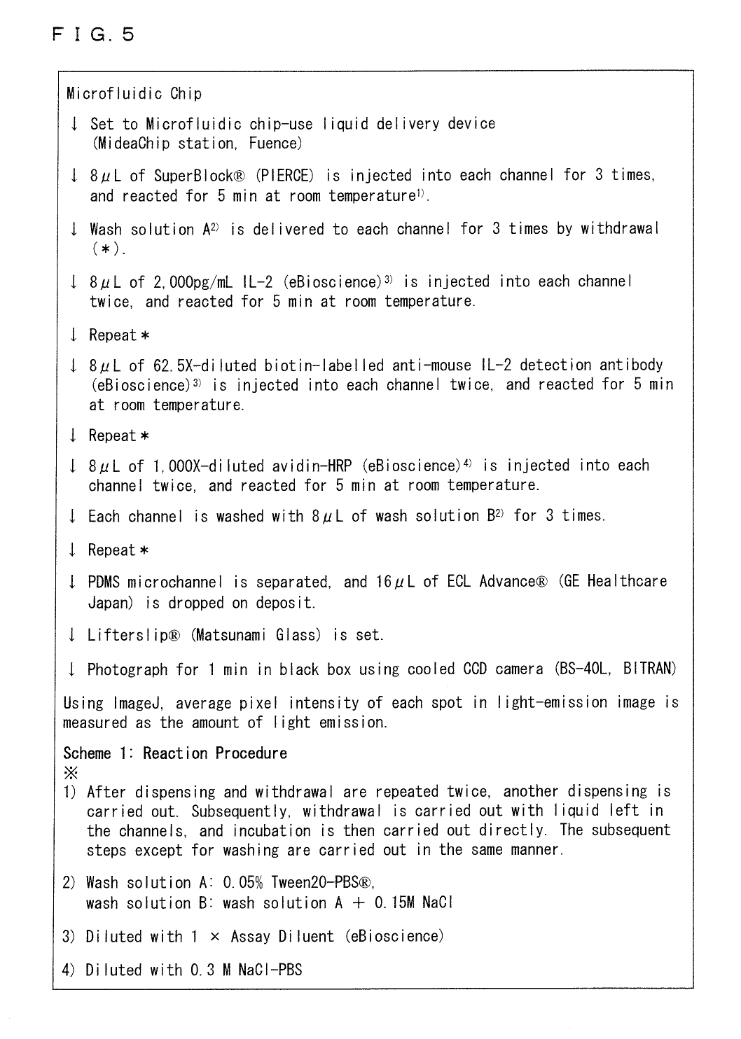

Using a fluorescence filter (U-NIBA3, manufactured by Olympus Corporation), the particle count of the fluorescent beads contained in each of the spots (250 μm in width, 750 μm in length) on the microfluidic chip was measured under the fluorescence microscope manufactured by Olympus Corporation. Then, according to Scheme 1 shown in FIG. 5, blocking was carried out by using SuperBlock® (PIERCE). Thereafter, injection of IL-2 antigen (eBioscience), injection of biotin-labelled anti-mouse IL-2 detection antibody (eBioscience), and injection of avidin-HRP (eBioscience) were sequentially carried out for an antigen-antibody reaction, after which spots having reacted by enzymatic chemiluminescence were detected.

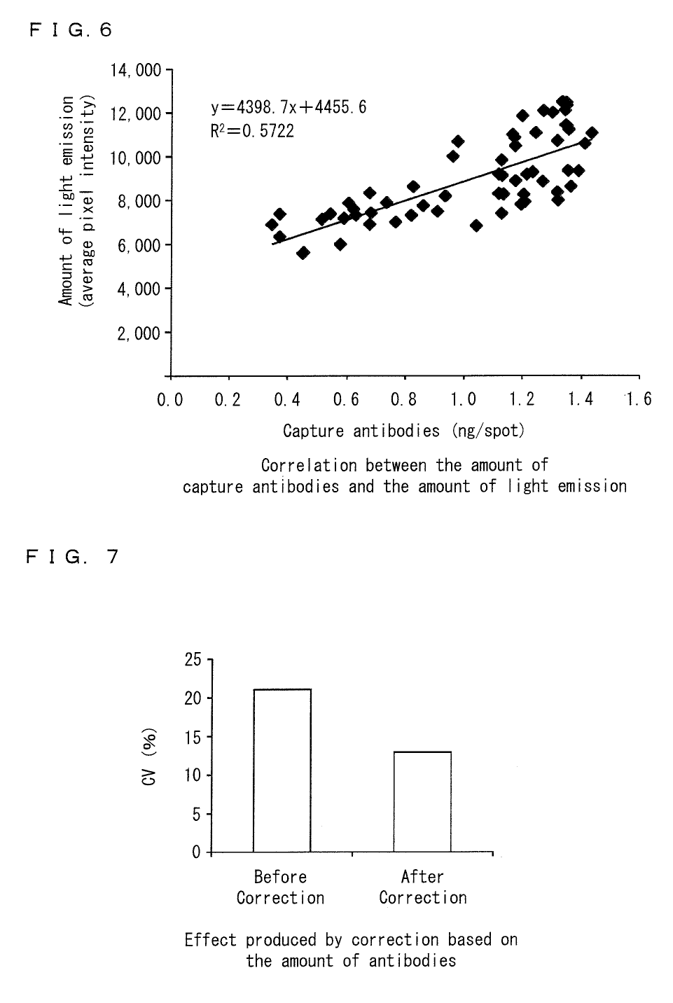

The result is shown in FIG. 6. From the concentration ratio of the capture antibodies (probes) to the fluorescent beads (particulate substances), the amount of capture antibodies for one fluorescent bead in the sprayed sample (liquid) is approximately 2.40 pg. From the number of fluorescent beads in the spot, the amount of capture antibodies applied in the spot (the number of fluorescent beads×2.40 pg) could be calculated.

For each of 60 spots having been observed as emitting artifact-free light, the amount of capture antibodies was calculated from the number of fluorescent beads. Then, it was examined if there might be a correlation between the calculated amount of capture antibodies and the luminescence value obtained by enzymatic chemiluminescence in each of the spots. As a result of the examination, linearity of R²=0.5722 was found as shown in FIG. 6. In other words, a correlation was shown between the amount of capture antibodies applied and the luminescence value obtained by enzymatic chemiluminescence.

Thus, by preliminary examination of microfluidic chips in terms of the amount of capture antibodies in the spot through use of the fluorescent beads, a microfluidic chip having the capture antibodies in a certain amount immobilized thereon is selected, or supplementary capture antibodies are added to a microfluidic chip having insufficient capture antibodies. This makes it possible to maintain the amount of capture antibodies in each of the spots constant and to thus improve the quality of the microfluidic chip.

By use of a correlation equation of the amount of capture antibodies and the amount of light emission (luminescence value) shown in FIG. 6, correction was made by dividing the measured amount of light emission by the amount of light emission found from the amount of capture anditidies contained in one spot. As to the uniformity as a whole, the coefficient of variation (CV) was improved from 21% to 13% (see FIG. 7). Thus, correction of the measured value based on the amount of probes in the spot can also bring about improvement of the quality of the obtained measured value data.

### Reference Example 4

### Study of Suitable Particle Sizes of the Fluorescent Beads

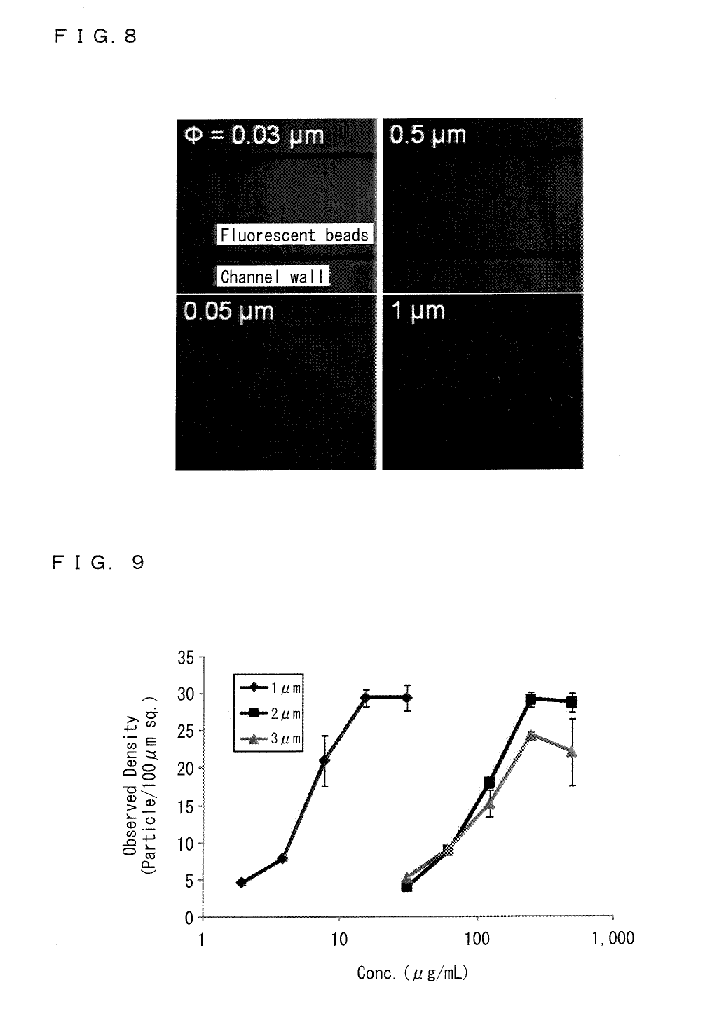

Under the conditions as in Reference Example 2, the fluorescent beads having mean particle sizes of 0.03 μm (fluorescent yellow-green), 0.05 μm (fluorescent orange), 0.5 μm (fluorescent orange), and 1 μm (fluorescent orange) (all of these fluorescent beads are latex beads, carboxylate-modified polystyrene (aqueous suspension) manufactured by Sigma-Aldrich Corporation) were exposed to excitation light for 5 seconds and then observed under the fluorescence microscope at a 5× magnification. As shown in FIG. 8, the result of the observation under the above experimental conditions showed that the smallest particle size of the fluorescent beads that could be individually observed in particle forms was 1 μm. That is why 1 μm is the lower limit of the particle size of the practical fluorescent beads under the conditions in Reference Example 2. Note that the observable particle size of the fluorescent beads can vary with changes in size of a spot to be formed, type of the fluorescent beads, conditions for observation, etc.

### Reference Example 5

### Study of Suitable Density and Number of Beads

Using beads having particles sizes of 1 μm to 3 μm, an upper limit of a density of the beads was studied. Using two types of fluorescent beads having a mean particle size of 1 μm (see Reference Example 2) (in concentrations of 2 μg/mL, 4 μg/mL, 8 μg/mL, 16 μg/mL, and 31 μg/mL) and a mean particle size of 2 μm (Latex beads, carboxylate-modified polystyrene, fluorescent orange (aqueous suspension) manufactured by Sigma-Aldrich Corporation) (in concentrations of 31 μg/mL, 63 μg/mL, 125 μg/mL, 250 μg/mL, and 500 μg/mL), a fluorescent image was photographed in the same manner under the microscope at a 5× magnification under the conditions as in Reference Example 2. Then, using ImageJ, the particle count of the fluorescent beads present in the 250 μm-wide and 750 μm-long area was determined in the same manner. As for the beads having a particle size of 3 μm (in concentrations of 31 μg/mL, 63 μg/mL, 125 μg/mL, 250 μg/mL, and 500 μg/mL), non-fluorescent latex beads (aqueous suspension, manufactured by Sigma-Aldrich Corporation) were used. They were irradiated with white light from above, and light scattered from the beads was detected.

The result of the study is shown in FIG. 9. In the case where the particle sizes of the fluorescent beads are 1 μm and 2 μm, a direct correlation was shown between the concentration of the fluorescent beads and the particle count of the fluorescent beads if not more than 30 particles are present in a 100 square micrometer area of the spot. Thus, a good result was obtained. In the case where the beads having a particle size of 3 μm were observed under light scattered therefrom, a direct correlation was shown between the concentration of the beads and the particle count of the beads if not more than 24 particles are present in a 100 square micrometer area of the spot. Thus, a good result was obtained.

Note that the bounds within which a direct correlation is shown between the concentration of the beads and the particle count of the beads can vary with change of conditions for the measurement or other conditions. Thus, the present invention is applicable even to a case where more than 30 particles are present in a 100 square micrometer area of the spot.

As shown in Reference Examples and Example, each of the fluorescent beads has a fluorescent dye contained in its base material. Therefore, no changes in fluorescence value of the fluorescent beads occur because ambient environments of the fluorescent dye are not changed even when the fluorescent beads are dried upon application to the substrate. However, the fluorescence value of the fluorescent beads decreases by an amount of the base material even when the same amount of fluorescent dye is used. For this reason, it was not practical to evaluate the amount of spot on the basis of the fluorescence value of the fluorescent beads. On the other hand, it was found that the particle count is higher than the fluorescence value in sensitivity for detection of the fluorescent beads, and that the particle count of the fluorescent beads is thus more suitable for evaluation of the amount of deposit. Further, the particle count is beneficial for the following reasons. That is, the fluorescent beads, which are detected in particle forms, are detectable as long as the fluorescence value of the fluorescent beads is higher than that of the background. Besides, the measurement result is less susceptible to bleaching of fluorescence due to exposure to outside light or change in intensity of excitation light. Since the fluorescent beads can be easily separated from the background without confocal laser microscope or the like, the measurement of the particle count is possible with use of a relatively inexpensive measurement device, as compared with the measurement of the fluorescence value.

### INDUSTRIAL APPLICABILITY

The present invention provides a novel method for estimating the amount of probes, such as nucleic acids or proteins, immobilized in a spot with a high degree of accuracy.

### REFERENCE SIGNS LIST

1 Computer (particle count measuring section, probe amount estimating section, quality evaluating section)
5 Microscope device (image capturing section)
10 Manufacturing apparatus

1. A method for estimating an amount of immobilized probes, comprising the successive steps of:
providing a sample on a substrate to form one or more spots on the substrate, the sample containing particulate substances and probes in a predetermined ratio, the probes being reactive with a predetermined target;
measuring the number of the particulate substances contained in at least one of the spots; and
estimating the amount of the probes contained in the at least one of the spots from the thus measured number of the particulate substances.

2. The method according to claim 1, wherein
the particulate substances are fluorescent beads.

3. The method according to claim 1, wherein
each of the particulate substances has a particle size in a range from 1 μm to 3 μm.

4. The method according to claim 1, wherein
such conditions that the particulate substances are contained at a density of not more than 30 particulate substances in a 100 square micrometer area of each of the spots, and that the number of the particulate substances contained per spot is not less than 100 are satisfied.

5. The method according to claim 1, wherein
the probes are of at least one type selected from a group consisting of nucleic acid sequences, proteins, and specific ligands of affinity tags.

6. The method according to claim 1, wherein
the spots are formed on the substrate as intersections of a pattern of the sample provided on the substrate and channels provided to cross the pattern of the sample.

7. The method according to claim 1, wherein
The sample is a liquid containing the particulate substances and the probes in a predetermined ratio.

8. A method for inspecting a quality of a substrate having probes immobilized thereon, comprising the step of:
estimating an amount of immobilized probes contained in two or more spots by a method according to claim 1, and then evaluating uniformity of the amount of immobilized probes from spot to spot.

9. A method for manufacturing a substrate having probes immobilized thereon, comprising the successive steps of:
estimating an amount of immobilized probes contained in two or more spots by a method according to claim 1, and then evaluating uniformity of the amount of immobilized probes from spot to spot; and
providing the probes to a spot having a shortage of probes to equalize the amount of immobilized probes from spot to spot.

10. The method according to claim 9, wherein
the step of equalizing the amount of immobilized probes is performed by providing the probes by electrospray deposition.

11. A method for manufacturing a substrate having probes immobilized thereon, comprising the successive steps of:
estimating an amount of immobilized probes contained in at least one of spots by a method according to claim 1, and then detecting a difference between the thus estimated amount of immobilized probes and an expected value of the amount of probes to be immobilized in the spot; and
providing the probes to a spot having a shortage of probes to eliminate the difference from the expected value.

12. The method according to claim 11, wherein
the step of eliminating the difference from the expected value is performed by providing the probes by electrospray deposition.

13. A probe immobilizing substrate comprising a substrate having one or more spots formed thereon, the spots containing particulate substances and probes in a predetermined ratio, the probes being reactive with a predetermined target.

14. A kit comprising:
a probe immobilizing substrate according to claim 13; and
a storage medium storing at least one of (i) the number of particulate substances contained in each of spots formed on the probe immobilizing substrate and (ii) an amount of probes contained in each of the spots, which amount has been estimated from the number of the particulate substances.

15. A method for correcting an amount of reacting targets, comprising the successive steps of:
estimating an amount of immobilized probes contained in at least one spot on a probe immobilizing substrate by a method according to claim 1, the probe immobilizing substrate comprising a substrate having one or more spots formed thereon, the spots containing particulate substances and probes in a predetermined ratio, the probes being reactive with a predetermined target;
causing the probe immobilizing substrate to be reacted with the target being reactive with the probes, so as to obtain a value of an amount of target having reacted with the probes; and
correcting the thus obtained value of the amount of target on a basis of the thus estimated amount of immobilized probes.

16. A manufacturing apparatus for manufacturing a probe immobilizing substrate comprising a substrate having one or more spots formed thereon, the spots containing particulate substances and probes in a predetermined ratio, the probes being reactive with a predetermined target,
the manufacturing apparatus comprising:
an image capturing section for capturing an image of the probe immobilizing substrate;
a particle count measuring section for analyzing the image of the probe immobilizing substrate having been obtained by the image capturing section, so as to measure the number of the particulate substances contained in each of the spots;
a probe amount estimating section for estimating an amount of the probes contained in each of the spots from the number of the particulate substances having been measured by the particle count measuring section; and
a quality evaluating section for evaluating a quality of the probe immobilizing substrate on a basis of the amount of immobilized probes having been estimated by the probe amount estimating section.

17. The manufacturing apparatus according to claim 16, comprising at least one of the following means:
spot forming means for manufacturing the probe immobilizing substrate whose image is to be captured by the image capturing section; and
spot modifying means for modifying a spot formed on a probe immobilizing substrate which has been judged as a nonconforming product by the quality evaluating section.
